(19) United States
(12) Patent Application Publication
(10) Pub. No.: US 2003/0110334 A1
(43) Pub. Date: Jun. 12, 2003

(54) HAVi-UPnP bridging

(75) Inventors: Peter J. Lanigan, Croydon (GB); Robin J. Blackwell, Redhill (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/304,271

(22) Filed: Nov. 26, 2002

(30) Foreign Application Priority Data
Dec. 6, 2001 (GB) 0129174.9

(51) Int. Cl. G06F 13/12

(52) U.S. Cl. 710/72

(57) ABSTRACT

A bridge (40) for bridges between a Home Audio-Video interoperability, HAVi, network (20) and a Universal Plug and Play, UPnP network (30). The bridge provides access to an entity on a hosting one of the networks to the other, accessing, network. The bridge (40) includes a bridge control unit generated for each entity. The bridge control unit (200, 210; 310, 320) includes a first element arranged to present a virtual representation of the entity to the accessing network and to accept communications for the virtual entity in the format of the accessing network and a second element in communication with the first element arranged to pass the accepted communications to the entity in the format of the hosting network. The first element and the second element are dynamically generated in dependence on the entity and a predetermined configuration.

The present invention relates to bridging HAVi and UPnP networks and is particularly applicable for use in home networks.

The number of consumer electronic devices and other home appliances with processing capabilities is constantly increasing. A comparable increase can also be seen in the number of computers, peripherals and other computer hardware used in the typical home or office. A number of competing standards and protocols allow devices and appliances to be networked and communicate. It is common for a single manufacturer to implement a control system that allows its devices and appliances to communicate, possibly share data and control each other. For example, a television may control a video or stereo. However, it is often the case that an appliance or device from one manufacturer will not be compatible with the control system of another manufacturer and therefore cannot control or communicate with other devices and appliances of that other manufacturer.

It is obviously desirable for a single standard to be agreed that will allow all manner of digital consumer electronics, home appliances, computers and the like to communicate with each other. With the arrival of broadband communications infrastructure and the digitization of audio and video appliances, such systems have been implemented giving simple control over complex technology.

Unfortunately, several networks based on different physical media (wired and wireless) and applications are expected to coexist in a digital home network. Common examples of wired physical media include the coaxial cable, twisted pair wiring, power line and optical fibres. A digital home network also needs to contend with the technological developments within the computer, consumer electronics, telephony and home automation industries. In order to address the differing needs required by differing physical media two standards have evolved:

1. Home Audio-Video interactivity (HAVI)

2. Universal Plug and Play (UPNP)

The first standard, Home Audio-Video interoperability (HAVi), started within the consumer industry as an attempt to accomplish high-speed interconnectivity over an IEEE 1394 serial bus network for transacting audio-visual data. HAVi is a digital AV networking initiative that provides a home networking software specification for seamless interoperability among home entertainment products. The HAVi specification is AV-device-centric and has been designed to meet the particular demands of digital audio and video. It defines an operating-system-neutral middleware that manages multi-directional AV streams, event schedules, and registries, while providing application program interfaces (APIs) for the creation of a new generation of software applications. HAVi software takes advantage of the powerful resources of chips built into modern audio and video appliances to give you the management function of a dedicated audio-video networking system. Devices and components are represented by Device Control Modules (DCMs) in a HAVi network whilst services and functionality offered by devices and components are represented by Functional Control Modules (FCMs). Each DCM and FCM is seen as an entity on the HAVi network that other entities can interact with and use. Within HAVI, there is a strong emphasis on enabling streaming applications in addition to control applications. An example of a streaming application would be an application transferring a video stream from a recording device to a decoder or display, while an example of a control application would be an application for programming the behaviour of devices. This implies support for both isochronous and asynchronous transactions.

The second standard is Universal Plug and Play (UPnP). While HAVI is intended primarily for a high speed IEEE 1394 network for Audio-Video (AV) transactions, UPNP can be implemented over many types of network (or within a PC). UPnP uses a version of the TCP/IP protocol stack and the Web to enable seamless proximity networking in addition to control and data transfer among networked devices in the home, office, and everywhere in between. The general notions and paradigms are based on the Internet protocols with additions to support the notions of plug and play. It enables data communication between any two devices under the command of any control device on the network. UPnP is independent of any particular operating system, programming language, or physical medium. Entities representing networked devices within a UPnP network include devices and services.

At present, there is no interoperability between the different standards to ensure that uniform control is possible. Devices within the HAVi network cannot interact and perform control functions with devices within UPNP network and vice-versa.

It will be appreciated that there is a need for harmonization of the two system approaches in order to ensure coexistence and interoperability of devices within these domains. The bridging of the two technological approaches. is thus desirable.

According to a first aspect of the present invention, there is provided a bridge for bridging between a Home Audio-Video interoperability, HAVi, network and a Universal Plug and Play, UPnP network and for providing access to an entity on a hosting one of the networks to the other, accessing, network, the bridge including a bridge control unit generated for each entity, the bridge control unit including a first element arranged to present a virtual representation of the entity to the accessing network and to accept communications for the virtual entity in the format of the accessing network and a second element in communication with the first element arranged to pass the accepted communications to the entity in the format of the hosting network, wherein the first element and the second element are dynamically generated in dependence on the entity and a predetermined configuration.

If the hosting network is the HAVi network, the entity may comprise a HAVi device, wherein the first element of the bridge control unit for the device comprises at least one of a virtual UPnP device and a virtual UPnP service of the device and the second element comprises a HAVi controller. The entity may comprise a HAVi DCM, wherein the first element of the bridge control unit for the device comprises a virtual UPnP device and the second element comprises a HAVi controller. The HAVi DCM may include one or more services, wherein the first element of the bridge control unit for the device includes one or more virtual UPnP services.

The hosting network may comprise the at least a portion of the HAVi network and the entity comprises a HAVi FCM, wherein the first element of the bridge control unit for the device comprises one or more virtual UPnP services and the second element comprises a HAVi controller.

The entity may comprise the HAVi network, wherein the first element of the bridge control unit for the device comprises a virtual UPnP device and the second element comprises a HAVi controller. The virtual UPnP device may include one or more virtual embedded devices each representing a part, one, or more DCMs or FCMs from the HAVi network. The virtual UPnP device may include one or more virtual embedded services each representing a part, one, or more DCMs or FCMs from the HAVi network.

If the hosting network comprises the UPnP network and the entity may comprise a device, wherein the first element of the bridge control unit for the device comprises at least one of a HAVi DCM and a HAVi FCM representing functionality of the device and the second element comprises a UPnP controller. The entity may include one or more UPnP services, wherein the first element of the bridge control unit for the device includes one or more DCM services. The entity may include one or more UPnP services wherein the first element of the bridge control unit for the one or more services includes one or more FCMs.

The entity may comprise at least a portion of the UPnP network, wherein the first element of the bridge control unit for the network comprises a DCM and the second element comprises a UPnP controller. The first element may include one or more FCMs representing the one or more devices. The UPnP network may include one or more services, wherein the first element includes one or more FCMs representing the one or more services.

The first element of the bridge control unit may include a unique identifier for the entity, wherein upon detecting a new entity the bridge is arranged to check for unique identifiers and to only generate a bridge control unit for an entity that has no unique identifier or a unique identifier that does not match those of other bridge control units provided by the bridge.

In the bridge control unit where the entity's host network is the UPnP network, it may include an attribute in an FCM or DCM of first element as the unique identifier.

In the bridge control unit where the entity's host network is the HAVi network, it may include an XML tag in the virtual UPnP device or service description as the unique identifier.

According to another aspect of the present invention, there is provided a method of bridging between a Home Audio-Video interoperability, HAVi, network and a Universal Plug and Play, UPnP network and for providing access to an entity on a hosting one of the networks to the other, accessing, network comprising:

generating a bridge control unit for each entity, the bridge control unit including a first element and a second element;

presenting a virtual representation of the entity to the accessing network from the first element;

accepting at the first element communications to the entity in the format of the accessing network;

passing the communications from the first element to the second element; and,

communicating the communications from the second element to the entity in the format of the hosting network,

wherein the first element and the second element are dynamically generated in dependence on the entity and a predetermined configuration.

The method may further comprise:

assigning a unique identifier for the entity to the first element of the bridge control unit;

upon detecting a new entity checking for unique identifiers; and,

only generating a bridge control unit for an entity that has no unique identifier or a unique identifier that does not match those of other bridge control units provided by the bridge.

Examples of the present invention will now be described in detail with reference to the accompanying drawings, in which:

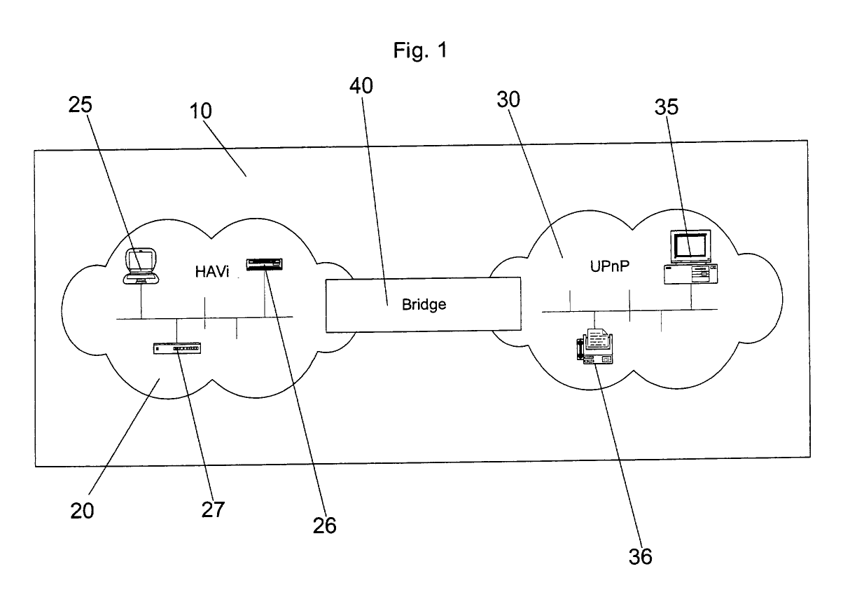

FIG. 1 is a schematic diagram of a HAVi network and a UPnP network linked through a bridging device according to an embodiment of the present invention;

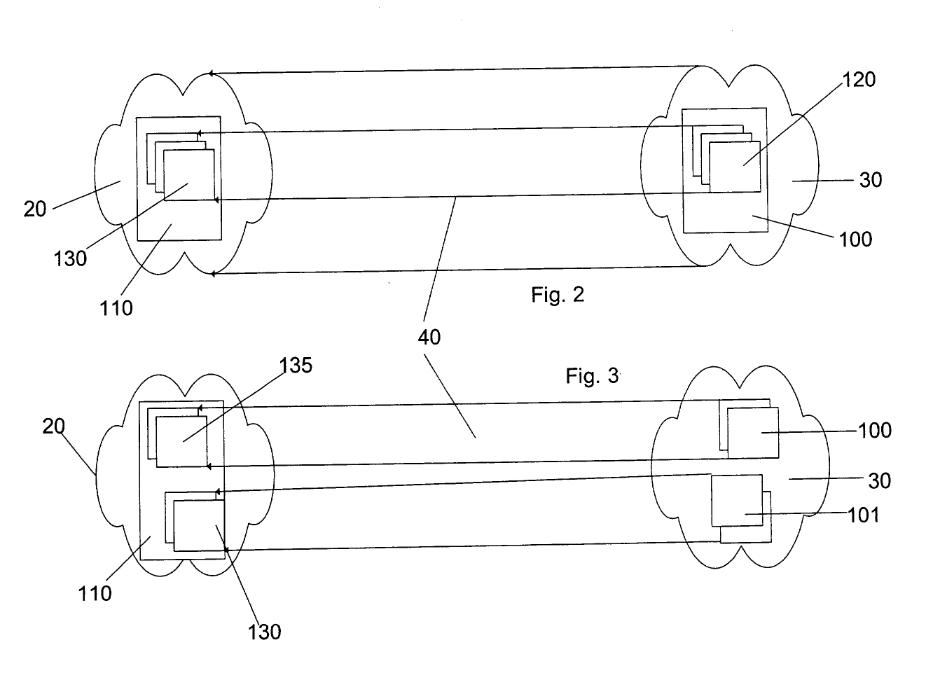

FIG. 2 is a schematic diagram illustrating a representation of UPnP devices and services in the HAVi network according to an embodiment of the present invention;

FIG. 3 is a schematic diagram illustrating a representation of UPnP devices and services in the HAVi network according to another embodiment of the present invention;

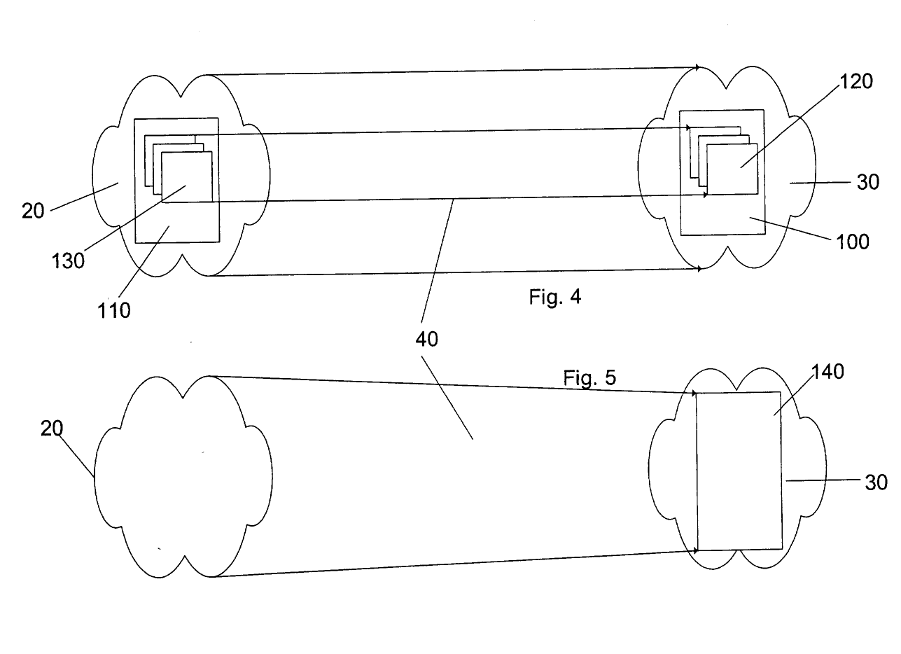

FIG. 4 is a schematic diagram illustrating the representation of HAVi DCMs and FCMs in the UPnP network according to an embodiment of the present invention;

FIG. 5 is a schematic diagram illustrating a representation of HAVi DCMs and FCMs in the UPnP network according to another embodiment of the present invention;

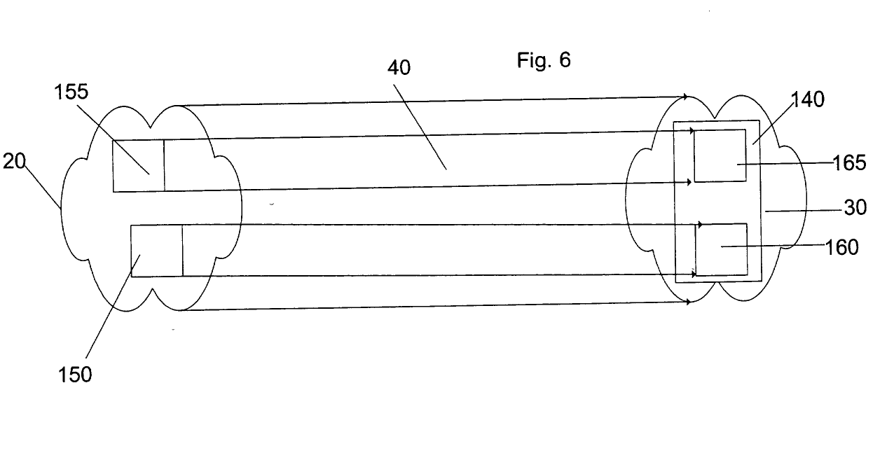

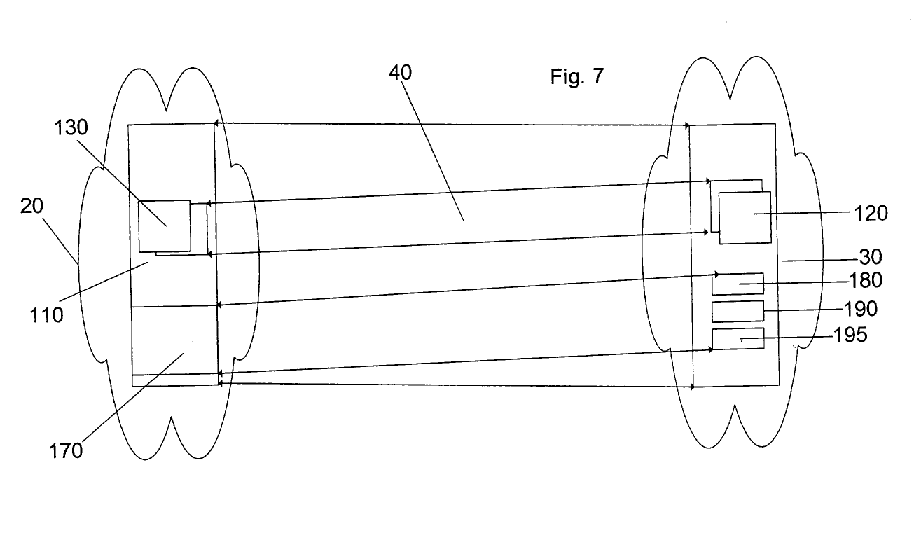

FIG. 6 is a schematic diagram illustrating a representation of HAVi DCMs and FCMs in the UPnP network according to another embodiment of the present invention;

FIG. 7 is a schematic diagram illustrating a representation of HAVi DCMs and FCMs in the UPnP network and of UPnP devices and services in the HAVi network according to another embodiment of the present invention;

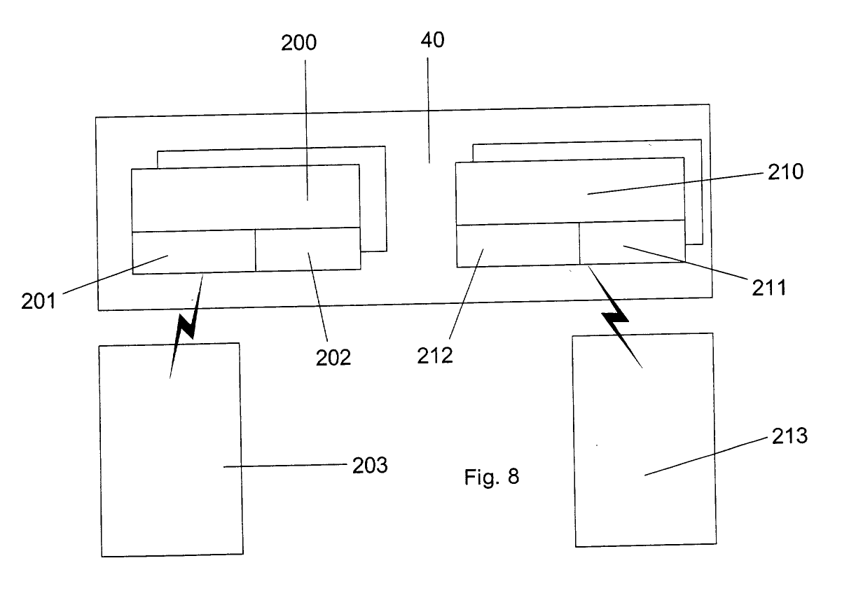

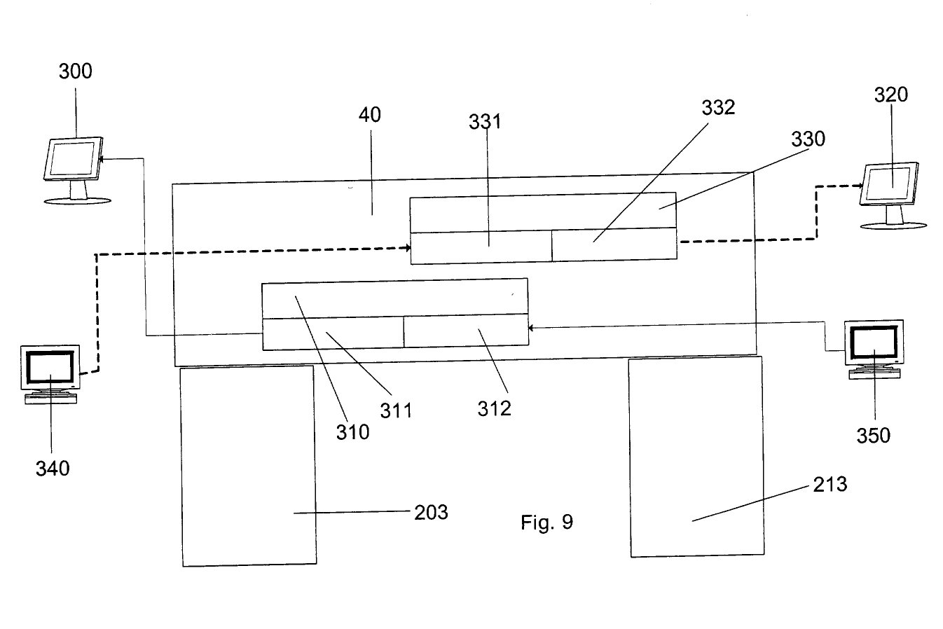

FIG. 8 is a schematic diagram illustrating the bridging device of FIG. 1 in more detail, and

FIG. 9 is a schematic diagram similar to FIG. 8, illustrating a more complex configuration.

FIG. 1 is a schematic diagram of a HAVi network and a UPnP network linked through a bridging device according to one embodiment of the present invention. A network 10 includes a HAVi based network 20 and a UPnP based network 30 that are bridged together by a bridge 40. Nodes 25 and 35 are displays where the user can view the network topology and can control, through an appropriate user interface, any node (25, 26, 27, 36) on either network 20, 30. From node 25, the user can, for example, detect the connection of node 36 to the UPnP network 30 and can control it. In a similar manner, a user at node 35 on the UPnP network 30 can detect the appearance of a new HAVi device within the HAVi network 20 and can control it.

The bridge 40 exists in both the HAVi network 20 and the UPnP network 30.

In FIG. 1, the two networks 20, 30 are shown as each using a different physical media. However, the present invention is equally applicable where HAVi and UPnP networks are implemented over the same physical media.

FIG. 2 is a schematic diagram illustrating a representation of UPnP devices and services in the HAVi network according to an embodiment of the present invention. In the HAVi network 20, each UPnP device 100 within the UPnP network 30 is mapped to a virtual DCM 110 provided by the bridge 40 to the HAVi network 20. UPnP services 120 (such as a controller for the settings of a television's picture or sound) from the UPnP network 30 are mapped to one or more virtual FCMs 130 (M FCMs may represent N services) provided by the bridge 40 to the HAVi network 20. The bridge 40 accepts communications and control commands from the HAVi network 20 for the virtual DCMs 110 and FCMs 130, translates them and forwards them to their mapped UPnP devices 100 or services 120.

FIG. 3 is a schematic diagram illustrating a representation of UPnP devices and services in the HAVi network according to another embodiment of the present invention. In the HAVi network 20, the whole UPnP network 30 is mapped to a virtual DCM 110 provided by the bridge 40 to the HAVi network 20. N UPnP devices 100, 101 within the UPnP network 30 are respectively mapped to M virtual FCMs 130, 135 provided by the bridge 40 to the HAVi network 20. Any UPnP services would also be mapped to virtual FCMs. The bridge 40 accepts communications and control commands from the HAVi network 20 for the virtual DCM 110 and FCMs 130, 135, translates them and forwards them to their mapped UPnP devices 100, 101.

FIG. 4 is a schematic diagram illustrating a representation of HAVi DCMs and FCMs in the UPnP network according to an embodiment of the present invention. In the UPnP network 30, each HAVi DCM within the HAVi network 20 is mapped to a virtual UPnP device provided by the bridge 40 to the UPnP network 30. FCMs from the HAVi network 20 are mapped to one or more virtual UPnP services provided by the bridge 40 to the UPnP network 30. The bridge 40 accepts communications and control commands from the UPnP network 30 for the virtual devices and services, translates them and forwards them to the mapped HAVi DCM or FCM.

FIG. 5 is a schematic diagram illustrating a representation of HAVi DCMs and FCMs in the UPnP network according to another embodiment of the present invention. The HAVi network 20 is mapped to a single virtual UPnP device 140 provided by the bridge 40. The bridge 40 accepts communications and control commands from the UPnP network 30 for the virtual devices and services, translates them and forwards them to the HAVi network 20.

FIG. 6 is a schematic diagram illustrating a representation of HAVi DCMs and FCMs in the UPnP network according to another embodiment of the present invention. The HAVi network 20 is mapped to a single virtual UPnP device 140 provided to the UPnP network 30 by the bridge 40. Within the single virtual device 140 are virtual embedded UPnP devices or services 160, 165 that are mapped to HAVi DCMs/FCMs 150, 155. Typically, a virtual device or a virtual device and one or more virtual services are mapped to HAVi DCMs whilst one or more services map to HAVi FCMs.

FIG. 7 is a schematic diagram illustrating a representation of HAVi DCMs and FCMs in the UPnP network and of UPnP devices and services in the HAVi network according to another embodiment of the present invention. This representation follows that of FIG. 4 in that each DCM is mapped to a virtual UPnP device provided by the bridge 40 to the UPnP network 30 and FCMs are mapped to one or more virtual UPnP services provided by the bridge 40 to the UPnP network 30. However, in UPnP networks, devices provide no APIs (application program interface) themselves because all control and interaction is via embedded services. In HAVi, DCMs do provide some services such as description, scheduling, power management and stream management. The illustrated representation shows the representation provided by the bridge for both the HAVi and UPnP networks. Typically only one side of the bridge will be ‘virtual’ (provided by the bridge) as the other side will be handled by the actual device. In the HAVi network 20, a virtual DCM 110 provided by the bridge 40 includes a number of DCM services 170 that are mapped to embedded services of a UPnP device. Conversely, in the UPnP network 30, a virtual device 100 provided by the bridge 40 services 180-195 associated with the virtual device 100 and mapped to the DCM in the HAVi network 20. HAVi services relating to description of the device are implemented as device description functions (for example, GetDevicelcon, GetDeviceManufacturer) within the virtual device 100. As is illustrated, a selected number of DCM services may be mapped to one or more UPnP services.

FIG. 8 is a schematic diagram illustrating the bridging device of FIG. 1 in more detail.

The bridge 40 includes a number of bridge code units (BCU) 200, 210. For representations within the HAVi network 20, a BCU 200 includes the virtual DCMs and/or FCMs 201 and a UPnP Control Point 202. A HAVi stack 203 is provided for the virtual DCMs and FCMs 201 to operate. For representations within the UPnP network 30, a BCU 210 includes the virtual devices and/or services 211 and a HAVi control application 212. A UPnP stack 213 is provided for the virtual devices and services 211 to operate.

FIG. 9 is the schematic diagram of FIG. 8 illustrating a more complex configuration.

In the bridge illustrated with reference to FIG. 8, it is assumed that all devices in the same network could be represented using the same type of BCU. However, it will be apparent from the mappings discussed above that some configurations may require different bridge setups to others.

In the illustrated embodiment, a HAVi device 300 is mapped to a a first BCU 310 in the bridge 40 whilst a UPnP controller 320 is mapped to a second BCU 330 of a different type. The first BCU 310 includes a HAVi control application 311 for communicating with the HAVi device 300 and a UPnP device/service 312 for providing a virtual representation of the device 300 on the UPnP network. The second BCU 330 includes a HAVi DCM/FCM 331 for providing a virtual representation of the device 320 on the HAVi network and a UPnP control application 332 for communicating with the UPnP device 320.

Communications from a HAVi controller 340 for the virtual representation of the UPnP device 320 are routed to the HAVi DCM/FCM 301 which passes them to the UPnP control application 302 and on to the UPnP device 320. Communications from a UPnP controller 350 for the virtual representation of the HAVi device 300 are routed to the UPnP device/service 312 which passes them to the HAVi control application 311 and on to the HAVi device 300.

It will be appreciated that FIGS. 8 and 9 only illustrated two of a number of different bridge configurations. Indeed, a bridge may be configured to dynamically generate BCUs depending on connected devices and services and the mappings selected to represent them.

Although each of the representations of FIGS. 2 to 7 have been discussed in isolation, it will be apparent that a bridge using the configuration of FIG. 8 or 9 could be implemented using any or all of the representations to bridge HAVi and UPnP networks together.

Although the bridge provides virtual representations of HAVi DCMs/FCMs as UPnP devices and services and also provides virtual representations of UPnP devices and services as HAVi DCMs/FCMs, a device may be capable of accessing both the HAVi and UPnP network. In such a case it may be preferable to use the virtual representation over controlling the actual device or vice-versa. Furthermore it may be preferable to prevent the bridge creating a virtual representation for a device that is already present on a network (this would also prevent a feedback of objects from one network being represented by the bridge on another and then bridged back again, especially if there is more than one bridge in the network). To avoid such problems the virtual representations are identified as such by a unique identifier for the device they represent.

Examples of achieving the virtual representation include:

HAVi

Define an attribute ATT_DEVICE_UPNP which takes boolean values. The attribute is set to true when the DCM/FCM represents a UPnP object and false otherwise (this is equivalent to the attribute not being present). The attribute is registered in the HAVi registry in the normal way and can be queried by interested entities.

Define an API for virtual DCMs/FCMs of the format:

Status DCM/FCM::GetUPnPID(out UUID upnpId) This would return the UUID of the UPnP object represented by the DCM/FCM or an error if the DCM/FCM did not represent a UPnP object (the error would normally be NOT_IMPLEMENTED or EUNKNOWN_MESSAGE).

UPnP

Define a new XML tag for UPnP descriptions:

<HAVIHUID> representation of an HUID</HAVIHUID> The presence of the tag would indicate that the description represented a HAVi object.

1. A bridge for bridging between a Home Audio-Video interoperability, HAVi, network and a Universal Plug and Play, UPnP network and for providing access to an entity on a hosting one of the networks to the other, accessing, network, the bridge including a bridge control unit generated for each entity, the bridge control unit including a first element arranged to present a virtual representation of the entity to the accessing network and to accept communications for the virtual entity in the format of the accessing network and a second element in communication with the first element arranged to pass the accepted communications to the entity in the format of the hosting network, wherein the first element and the second element are dynamically generated in dependence on the entity and a predetermined configuration.

2. A bridge according to claim 1, in which the hosting network comprises the HAVi network and the entity comprises a HAVi device, wherein the first element of the bridge control unit for the device comprises at least one of a virtual UPnP device and a virtual UPnP service of the device and the second element comprises a HAVi controller.

3. A bridge according to claim 1, in which the hosting network comprises the HAVi network and the entity comprises a HAVi DCM, wherein the first element of the bridge control unit for the device comprises a virtual UPnP device and the second element comprises a HAVi controller.

4. A bridge according to claim 3, in which the HAVi DCM includes one or more services, wherein the first element of the bridge control unit for the device includes one or more virtual UPnP services.

5. A bridge according to claim 1, in which the hosting network comprises the at least a portion of the HAVi network and the entity comprises a HAVi FCM, wherein the first element of the bridge control unit for the device comprises one or more virtual UPnP services and the second element comprises a HAVi controller.

6. A bridge according to claim 1, in which the hosting network comprises the HAVi network and the entity comprises the HAVi network, wherein the first element of the bridge control unit for the device comprises a virtual UPnP device and the second element comprises a HAVi controller.

7. A bridge according to claim 6, in which the virtual UPnP device includes one or more virtual embedded devices each representing a part, one, or more DCMs or FCMs from the HAVi network.

8. A bridge according to claim 6, in which the virtual UPnP device includes one or more virtual embedded services each representing a part, one, or more DCMs or FCMs from the HAVi network.

9. A bridge according to claim 1, in which the hosting network comprises the UPnP network and the entity comprises a device, wherein the first element of the bridge control unit for the device comprises at least one of a HAVi DCM and a HAVi FCM representing functionality of the device and the second element comprises a UPnP controller.

10. A bridge according to claim 9, in which the entity includes one or more UPnP services, wherein the first element of the bridge control unit for the device includes one or more DCM services.

11. A bridge according to claim 1, in which the hosting network comprises the UPnP network and the entity includes one or more UPnP services wherein the first element of the bridge control unit for the one or more services includes one or more FCMs.

12. A bridge according to claim 1, in which the hosting network comprises the UPnP network and the entity comprises at least a portion of the UPnP network, wherein the first element of the bridge control unit for the network comprises a DCM and the second element comprises a UPnP controller.

13. A bridge according to claim 12, in which the UPnP network includes one or more devices, wherein the first element includes one or more FCMs representing the one or more devices.

14. A bridge according to claim 12, in which the UPnP network includes one or more services, wherein the first element includes one or more FCMs representing the one or more services.

15. A bridge according to claim 1, in which the first element of the bridge control unit includes a unique identifier for the entity, wherein upon detecting a new entity the bridge is arranged to check for unique identifiers and to only generate a bridge control unit for an entity that has no unique identifier or a unique identifier that does not match those of other bridge control units provided by the bridge.

16. A bridge according to claim 15, in which the bridge control unit where the entity's host network is the UPnP network includes an attribute in an FCM or DCM of first element as the unique identifier.

17. A bridge according to claim 15, in which the bridge control unit where the entity's host network is the HAVi network includes an XML tag in the virtual UPnP device or service description as the unique identifier.

18. A method of bridging between a Home Audio-Video interoperability, HAVi, network and a Universal Plug and Play, UPnP network and for providing access to an entity on a hosting one of the networks to the other, accessing, network comprising:
generating a bridge control unit for each entity, the bridge control unit including a first element and a second element;
presenting a virtual representation of the entity to the accessing network from the first element;
accepting at the first element communications to the entity in the format of the accessing network;
passing the communications from the first element to the second element; and,
communicating the communications from the second element to the entity in the format of the hosting network,
wherein the first element and the second element are dynamically generated in dependence on the entity and a predetermined configuration.

19. A method according to claim 18, further comprising:
assigning a unique identifier for the entity to the first element of the bridge control unit;
upon detecting a new entity checking for unique identifiers; and,
only generating a bridge control unit for an entity that has no unique identifier or a unique identifier that does not match those of other bridge control units provided by the bridge.

20. A method according to claim 19, in which the bridge control unit where the entity's host network is the UPnP network includes an attribute in an FCM or DCM of first element as the unique identifier.

21. A method according to claim 19, in which the bridge control unit where the entity's host network is the HAVi network includes an XML tag in the virtual UPnP device or service description as the unique identifier.

22. A computer program comprising computer program code means for performing all of the steps of claims 19 when said program is run on a computer.

23. A computer program as claimed in claim 22 embodied on a computer readable medium.
